(19) United States
(12) Patent Application Publication
(10) Pub. No.: US 2005/0038155 A1
(43) Pub. Date: Feb. 17, 2005

(54) Thermoplastics exhibiting excellent long-term hydrostatic strength for high-pressure applications

(76) Inventors: Stephane Berghmans, Gent (BE); Mark Boelens, Meise (BE)

Correspondence Address: Milliken & Company, P. O. Box 1927, Spartanburg, SC, 29304, US

(21) Appl. No.: 10/639,550

(22) Filed: Aug. 12, 2003

(51) Int. Cl. C08L 1/00

(52) U.S. Cl. 524/284

(57) ABSTRACT

Novel thermoplastics and pipes made therefrom which can withstand extreme surface and/or internally generated pressures that make them excellent candidates for uses such as within underground liquid and gas transport systems are provided. Such pipes are improvements over standard metal (i.e., steel, copper, lead, and the like), concrete, ceramic, and the like, pipes due to toxicity issues (such as with lead pipes), raw material costs (such as with copper), construction costs, shipping costs, implementation costs (particularly underground), flexibility (and thus modulus strength allowances) to compensate for underground movements (i.e., earthquakes and tremors), non-rusting characteristics, reduced crack propagation possibilities, and ease in manufacture. Such thermoplastics exhibit excellent long-term hydrostatic strength characteristics that permit potential long-term reliable usage in such underground conditions and are preferably made from resins that include nucleating agents that provide such needed properties therein.

### FIELD OF THE INVENTION

The present invention generally relates to novel thermoplastics and pipes made therefrom which can withstand extreme surface and/or internally generated pressures that make them excellent candidates for high-pressure uses, such as, as one non-limiting example, within underground liquid and gas transport systems. Such high-pressure articles (pipes, for instance) are improvements over standard metal (i.e., steel, copper, lead, and the like), concrete, ceramic, and the like, articles due to toxicity issues (such as with lead pipes), raw material costs (such as with copper), construction costs, shipping costs, implementation costs (particularly underground), flexibility (and thus modulus strength allowances) to compensate for underground movements (i.e., earthquakes and tremors), non-rusting characteristics, reduced crack propagation possibilities, and ease in manufacture. Such thermoplastics exhibit excellent long-term hydrostatic strength characteristics that permit potential long-term reliable usage in underground conditions and are preferably made from resins that include nucleating agents that provide such needed properties therein.

### BACKGROUND OF THE INVENTION

Underground transport of liquids and gases has been utilized for many years. Such underground transport has proven to be the most efficient and safest manner in which to transport potentially explosive, flammable, and/or toxic liquids (such as crude oil, for example) and gases (such as methane and propane, as examples) long distances. The principal method followed to provide such long distance underground transport has been through metal tubes and pipes. In the past, the utilization of metals (such as steel, copper, lead, and the like) was effective from cost and raw material supply perspectives. However, with the population growing throughout the world and the necessity for transporting liquids and gases to more remote locations increases, the continued utilization of such metal articles has become more and more difficult for a number of reasons, such as transportation costs and complexities associated with pre-preproduced and heavy metal articles, rust and/or corrosion and thus potential for cracking and leaking of metals, and the difficulty of replacing any cracked or leaking metal pipes within underground channels, among other reasons. Furthermore, although such metal pipes are designed to withstand such high pressures (i.e., above 8 bars, for instance), once a crack develops within the actual metal pipe structure, it has been found that such cracks easily propagate and spread in size and possibly number upon the application of continued high pressure to the same weakened area. In such an instance, failure of the pipe is therefore imminent unless closure is effectuated and repairs or replacements are undertaken. Not to mention, the weight, cost, breakability (during storage and/or transport), and other characteristics of other commonly used pipe materials (such as concrete, ceramic, and the like) have made thermoplastics an attractive alternative as well.

Although there is a need to produce new pipelines to remote locations around the world, there is also a need to replace the now-deteriorating pipelines already in use. Aging pipelines, primarily made of metals, such as steel, copper, and the like, have recently caused great concern as to their safety. Unexpected explosions have occurred within such old metal pipelines with tragic consequences. Thorough review and replacement of such old metal pipes is thus necessary; however, due to the difficulties in determining the exact sections of such pipelines which require replacement, there is a desire to completely replace old pipelines but following the same exact routes. Again, due to the difficulties noted above, there is a perceived need to develop more reasonable, safer, longer-lasting, easier-to-install, non-rusting, non-crack propagating, and more flexible pipeline materials.

Thermoset or thermoplastic pipes and pipelines have been utilized in certain applications for many years. However, such uses have been limited, generally to low-pressure applications due to the fact that metals exhibit higher pressure thresholds than such thermosets or thermoplastics. Thus, in order to supplant questionable metal materials for higher pressure applications (i.e., 20 bars or above), there is a need to provide long-term reliable thermoplastic pipe materials exhibiting sufficiently high hydrostatic strength over a long period of time (for example, 50 years or more). The thermoplastic materials currently provided today lack such a long-term high pressure strength characteristic, at least to the extent that reliability for long periods of time is not in doubt. Thus, there simply is no viable alternative presented to date within the pertinent thermoplastic prior art which accords the underground liquid and gas transport industry a manner of replacing such high pressure metal, concrete, ceramic, etc., articles with regard to such long-term hydrostatic properties.

### SUMMARY AND DESCRIPTION OF THE INVENTION

It is thus an object of this invention to provide a viable alternative to high-pressure questionable metal materials. Another object of this invention is to provide a suitable and reliable thermoplastic material for the replacement of the materials currently utilized for underground liquid- and gas-transport pipes. Yet another object of this invention is to provide a simple manner of providing a thermoplastic (polyolefin, such as polypropylene, for example) exhibiting sufficiently high reliable long-term hydrostatic strength for such high-pressure applications (pipes, as one non-limiting example).

Accordingly, this invention encompasses a nucleated thermoplastic formulation wherein said formulation exhibits a lower prediction limit ratio at least 3.0, preferably at least 3.2, more preferably at least 3.5, and most preferably at least 3.7, in comparison with a nonnucleated thermoplastic formulation of the same base resin, said lower prediction limit indicating long-term hydrostatic strength and performed in accordance with a full notch creep test for suitable solid plaque articles having dimensions of 100 mm by 6 mm by 6 mm and having a 1 mm notch cut into the middle portion therein. A high-pressure article (preferably, though not necessarily, a pipe) comprising such a nucleated thermoplastic formulation as above is also encompassed within this invention. Furthermore, such a nucleated thermoplastic formulation comprising at least one bicyclic nucleating agent or at least one cyclic dicarboxylate nucleating agent is also encompassed, as well as the method of forming such a formulation comprising the steps of introducing a bicyclic or cyclic dicarboxylate nucleating agent into a molten thermoplastic composition and permitting such a nucleated formulation to cool into a nucleated thermoplastic formulation and/or article. Thermoplastic formulations exhibiting such long-term hydrostatic strength, as well as certain pipes, either or both comprising specific nucleating agents, as noted below, are also encompassed within this invention.

The term “thermoplastic” is intended to encompass the well known polymeric compositions of any synthetic polymeric material that exhibits a modification in physical state from solid to liquid upon exposure to sufficiently high temperatures. Most notable of the preferred thermoplastic types of materials are polyolefins (i.e., polypropylene, polyethylene, and the like), polyester (i.e., polyethylene terephthalate, and the like), polyamides (i.e., nylon-1,1, nylon-1,2, nylon-6 or nylon-6,6), and polyvinyl halides (i.e., polyvinyl chloride and polyvinvyl difluoride, as merely examples). Preferred within this invention are polyolefins, and most preferred is polypropylene. Such materials are generally petroleum byproducts and are readily available worldwide. These materials are produced through the polymerization of similar or different monomers in a number of well-established commercial processes to yield, generally, pelletized resins. There are readily processed by melt extrusion of the polymerized materials in pellet form into the desired shape or configuration. Upon solidification through cooling, such materials exhibit extremely high pressure resistance, particularly upon introduction of nucleating agents, such as, as previously utilized in widespread applications, substituted or unsubstituted dibenzylidene sorbitols, available from Milliken & Company under the tradename Millad®, particularly 1,3-O-2,4-bis(3,4-dimethylbenzylidene) sorbitol (hereinafter DMDBS), available from Milliken Chemical under the trade name Millad® 3988, and/or certain sodium organic salts, available from Asahi Denka Kogyo K.K. such as sodium 2,2′-methylene-bis-(4,6-di-tert-butylphenyl) phosphate, available under the tradename NA-11™, or technologies based upon U.S. Pat. No. 5,342,868 that the addition of an alkali metal carboxylate to basic polyvalent metal salt of cyclic organophosphoric ester, available under the tradename NA-21™. Such nucleating agents are either mixed and provided within the pelletized polymers, or admixed within the melted polymer composition prior to extrusion. These compounds provide strength enhancements and accelerate thermoplastic production by producing crystalline networks within the final thermoplastic product upon cooling at relatively high temperatures. Theoretically, at least, with a stronger initial thermoplastic product, a more durable and potentially longer functional lifetime is provided by such a product.

The term “high-pressure article” is intended to encompass thermoplastic articles of any size or shape that can withstand internally and/or externally applied pressures of at least 8 bars. Such articles may be utilized for myriad applications, most notably as pipes for liquid and/or gas transport, either aboveground or underground. Other applications for such articles include, without limitation, liquid and/or gas storage devices (pressurized containers, for instance), plastic tanks (for fertilizers, alcoholic beverages, and the like, that may exhibit gas and/or vapor expansion properties during storage and/or transport), commode materials (particularly such materials as are prone to high air pressures in flushing systems), and the like.

For the preferred pipe applications, the wall thicknesses required to provide the desired high pressure characteristics are extremely high for standard thermoplastics (such as those including the nucleators noted above). Although such standard thermoplastic materials provide certain pressure resistances, in general the wall thickness required to withstand pressures of about 80 bars requires a standard diameter to wall thickness ratio of at most 11:1, although such a ratio is not intended to limit the breadth of this invention, only as a guide to standard characteristics of certain thermoplastics in terms of pressure properties. Thus, in order to provide such high pressure characteristics without exceeding the elongation at break limits of the polymeric materials present in pipe form (i.e, substantially cylindrical), with pipe diameter of, for example, about 232 millimeters (about 9 inches), the wall thickness of the pipe must be at least about 21 millimeters, or about 0.85 inches) to withstand such high pressures. Such thick walls may provide pressure resistance as well as resistance to crack propagation in certain situations; however, there is a strong desire to provide surface pressure resistance as well, not to mention the ability to reduce the amount of thermoplastic material required to provide such beneficial properties. There is thus a strong desire either to increase the pressure resistance (and thus consequently, the elongation at break characteristics) of the target thermoplastic to permit a highly effective polymeric pipe, or to reduce the amount of thermoplastic material necessary to provide pipes of the same pressure resistance characteristics as those noted above for standard nucleated thermoplastic materials. Burst pressure resistance has been provided in the past through the introduction of reinforcement materials within the target pipes themselves (such as metal, textile, and other like materials embedded within the pipes). However, such materials accord improvements in terms of burst pressure, but do not accord the same improvements in surface pressures.

It has now been found that the incorporation of certain nucleating agents can accord the necessary surface pressure resistance levels, at least through an initial standardized analytical method for measuring and ultimately extrapolating long-term hydrostatic strength to a 50-year period. As most pipes are utilized in underground applications, and after placement in such a position, underground pipes must be reliable for an extremely long duration, the thermoplastic utilized therein must also exhibit the same degree of needed reliability (e.g., the aforementioned 50 years). Previous nucleated thermoplastics do provide a certain level of such needed extrapolated long-term hydrostatic strength, but only to a limited extent. The nucleated thermoplastics noted within this invention have been found to provide an unforeseen improvement in such a pressure resistance level such that, as one example, the amount of thermoplastic necessary to meet a required gauge level can be reduced in comparison with the amounts required of prior nucleated thermoplastics.

The thermoplastic is preferably nucleated and most preferably comprises at least one nucleating agent compound selected from the group consisting of compounds conforming with either of formulae (I) or (II) 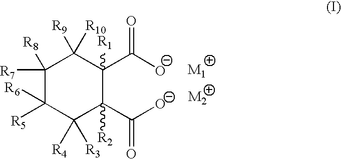
wherein M₁ and M₂ are the same or different or are combined to form a single moiety and are selected from at least one metal cation (such as, without limitation, sodium, potassium, calcium, strontium, lithium, and monobasic aluminum), and wherein R₁, R₂, R₃, R₄, R₅, R₆, R₇, R₈, R₉, and R₁₀ are either the same or different and are individually selected from the group consisting of hydrogen, C₁-C₉ alkyl [wherein any two vicinal (neighboring) or geminal (same carbon) alkyl groups may be combined to form a carbocyclic ring of up to six carbon atoms], hydroxy, C₁-C₉ alkoxy, C₁-C₉ alkyleneoxy, amine, and C₁-C₉ alkylamine, halogens (fluorine, chlorine, bromine, and iodine), and phenyl, wherein geminal constituents may be the same except that such geminal constituents cannot simultaneously be hydroxy; and wherein geminal constituents may be different from each other, except that such geminal constituents may not be hydroxy and halogen or hydroxy and amine simultaneously; 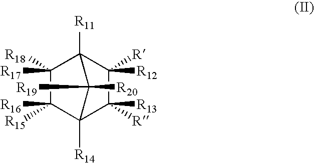
wherein R₁₁, R₁₂, R₁₃, R₁₄, R₁₅, R₁₆, R₁₇, R₁₈, R₁₉, and R₂₀ are individually selected from the group consisting of hydrogen, C₁-C₉ alkyl, hydroxy, C₁-C₉ alkoxy, C₁-C₉ alkyleneoxy, amine, and C₁-C₉ alkylamine, halogen, phenyl, alkylphenyl, and geminal or vicinal carbocyclic having up to nine carbon atoms, wherein geminal constituents may be the same except that such geminal constituents cannot simultaneously be hydroxy; and wherein geminal constituents may be different from each other, except that such geminal constituents may not be hydroxy and halogen or hydroxy and amine simultaneously; wherein R″ and R″ are the same or different and are individually selected from the group consisting of hydrogen, C₁-C₃₀ alkyl, hydroxy, amine, polyoxyamine, C₁-C₃₀ alkylamine, phenyl, halogen, C₁-C₃₀ alkoxy, C₁-C₃₀ polyoxyalkyl, C(O)—NR₂₁C(O), and C(O)O—R′″, wherein R₂₁ is selected from the group consisting of C₁-C₃₀ alkyl, hydrogen, C₁-C₃₀ alkoxy, and C₁-C₃₀ polyoxyalkyl, and wherein R′″ alone or two adjacent R′″ groups (such as when R′ and R″ are the same) are combined to from a single moiety which is selected from the group consisting of hydrogen, a metal ion (such as, without limitation, sodium, potassium, calcium, strontium, lithium, and monobasic aluminum), an organic cation (such as quaternary amines), polyoxy-C₂-C₁₈-alkylene, C₁-C₃₀ alkyl, C₁-C₃₀ alkylene, C₁-C₃₀ alkyleneoxy, a steroid moiety, phenyl, polyphenyl, C₁-C₃₀ alkylhalide, and C₁-C₃₀ alkylamine; and wherein at least one of R′ and R″ is either C(O)—NR₂₁C(O) or C(O)O—R′″. The term “monobasic aluminum” is well known and is intended to encompass an aluminum hydroxide group as a single cation bonded with the two carboxylic acid moieties. Furthermore, for Formula I, in each of these potential compounds, the stereochemistry at the metal carboxylates may be cis or trans, although cis is preferred. Calcium cis-hexahydrophthalate and disodium cis-hexahydrophthalate are preferred embodiments, although other metal ions, half esters, and pendant group substitutions as in the formula above, should provide similarly effective results. In Formula II, the stereochemistry at the R′ and R″ groups may be cis-exo, cis-endo, or trans, although cis-endo is preferred. Preferred embodiments of such a compound are disodium or calcium bicyclo[2.2.1]heptane-cis-endo-2,3-dicarboxylate, although other metal ions, half esters, and pendatn group substitutions as in the formula above, should provide similarly effective results.

Of enormous importance in this instance is the flexibility exhibited by the inventive pipes when subjected to external shear forces, for example earth tremors, and the like. Such flexibility permits the pipes to exhibit some movement in relation to the shear forces generated by such external occurrences. In the past, as noted above, metal pipes suffered from the lack of flexibility in that the application of such external shear forces would result in the burst of certain pipes due to such external forces exceeding the shear force threshold possessed by the metal materials. Such flexibility is most suitably measured in terms of tear resistance to the overall pipe article. In general, metal pipes exhibit at most a tear resistance of about 6% (copper exhibits the highest such tear resistance), which is extremely low when the potential for very strong shear forces underground are significant (particularly in certain parts of the world prone to earth tremors, earthquakes, and the like). Thermoplastics provide initial tear resistance measurements in excess of at least 20%, with a potential high measurement of more than about 100%, particularly upon incorporation of the sandwiched textile reinforcement material as discussed above. Thus, the inventive pipes should be able to withstand enormous shear forces, at least better than metal pipes, due to their exhibited tear resistance and thus flexibility characteristics.

The thermoplastic material layer or layers may comprise any number of additives for standard purposes, such as antimicrobial agents, colorants, antistatic compounds, and the like. Such antimicrobial agents would potentially protect the inner lining from colonization of unwanted and potentially dangerous bacteria (which could potentially create greater pressure within the pipes if a proper nutrition source is present). Preferably, such an antimicrobial agent would be inorganic in nature and relatively easy to introduce within the thermoplastic compositions within the pipe. Thus, silver-based ion-exchange compounds (such as ALPHASAN®, available from Milliken & Company, and other types, such as silver zeolites, and the like) are preferred for this purpose. Colorants may be utilized to easily distinguish the thermoplastic layers for identification purposes. Any pigment, polymeric colorant, dye, or dyestuff which is normally utilized for such a purpose may be utilized in this respect for this invention. Antistatic compounds, such as quaternary ammonium compounds, and the like, permit static charge dissipation within the desired thermoplastic materials in order to reduce the chances of instantaneous spark production which could theoretically ignite certain transported gases and/or liquids. Although the chances of such spark ignition are extremely low, such an additive may be necessary to aid in this respect. Furthermore, textile reinforcements may also be introduced between layers of thermoplastic material to add strength in terms of burst pressures, if desired.

Although only one specific layer of nucleated thermoplastic material is required, it is to be understood that more than one such layer is acceptable within this invention. Such additional layers may be of any type (and not necessarily thermoplastic and/or thermoset, or even nucleated thermoplastic, if desired), including, without limitation, metal, ceramic, glass-filled plastic, rubber, and the like.

Other alternatives to this inventive article will be apparent upon review of the preferred embodiments as discussed below.

### PREFERRED EMBODIMENTS OF THE INVENTION

The following Examples are provided merely to illustrate selected embodiments of the present invention and do not limit the scope of the claims.

Inventive and Comparative Nucleators

In accordance with Formulae (I) and (II), above, the preferred embodiments thereof and thus utilized within the Examples below were Calcium cis-Hexahydrophthalate and disodium bicyclo[2.2.1]heptane-2,3-dicarboxylate. In comparison thereof, a control thermoplastic (with no nucleator added) as well as thermoplastics samples comprising NA-11, NA-21, DMDBS, sodium benzoate, and talc were produced and tested. The results are as follows within the specified thermoplastics samples. For the Experimental Table 1 below, the following index of nucleators was utilized:

NUCLEATOR INDEX TABLE

| | | Amount |
|---|---|---|
| | Nucleator | Used (ppm) |
| Sample | | |
| A | Calcium cis-Hexahydrophthalate | 1500 |
| B | Calcium cis-Hexahydrophthalate | 2000 |
| C | disodium bicyclo[2.2.1]heptane- | 1500 |
| | 2,3-dicarboxylate | |
| D | disodium bicyclo[2.2.1]heptane- | 2000 |
| | 2,3-dicarboxylate | |
| (Comparatives) | | |
| E | none (Control) | — |
| F | DMDBS | 1000 |
| G | DMDBS | 2000 |
| H | Sodium Benzoate | 1000 |
| I | Talc | 1000 |
| J | NA-11 | 1000 |
| K | NA-21 | 1000 |
| L | NA-11 | 2000 |
| M | NA-21 | 2000 |

Base Thermoplastic Compositions

Thermoplastic compositions (plaques) were produced comprising the additives from the Examples above and sample random polyproylene (with some ethylene content) copolymer (RCP) resin plaques, produced dry blended in a Welex mixer at ˜2000 rpm, extruded through a single screw extruder at 205-220° C., and pelletized. Accordingly, one kilogram batches of target polypropylene were produced in accordance with the following table:

RANDOM COPOLYMER POLYPROPYLENE COMPOSITION TABLE

| Component | Amount |
|---|---|
| Polypropylene random copolymer (Repsol Isplen PR230 ®) | 1000 g |
| Irganox ® 1010, Primary Antioxidant (from Ciba) | 500 ppm |
| Irgafos ® 168, Secondary Antioxidant (from Ciba) | 1000 ppm |
| Calcium Stearate, Acid Scavenger | 800 ppm |
| Inventive Nucleator | as noted |

The base RCP and all additives were weighed and then blended in a Welex mixer for 1 minute at about 1600 rpm. All samples were then melt compounded on a Killion single screw extruder at a ramped temperature from about 205° to 220° C. through four heating zones. The melt temperature upon exit of the extruder die was about 220° C. The screw had a diameter of 2.54 cm and a length/diameter ratio of 24:1. Upon melting the molten polymer was filtered through a 60 mesh (250 micron) screen. Plaques of the target polypropylene were then made through compression molding of the pellets in a heated press. The plaques had dimensions of about 100 mm×6 mm×6 mm. These plaque formulations are, of course, merely preferred embodiments of the inventive article and method and are not intended to limit the scope of this invention.

The Long-Term Hydrostatic Strength (LTHS) is measured by exposing pipes to different stresses at different temperatures and recording the time elapsed before the pipe loses its dimensional stability and thus fails (via cracking, wall collapse, or the like). Generally, such experiments are run for at least 10,000 hours to permit reliable extrapolation of LTHS results for 50 years in estimation. The time consuming nature of such test protocol and the requirement of actual extruded pipes for such purposes, equivalent comparative analyses have been developed to permit similarly reliable results for predictability in terms of effective thermoplastic pipe materials. Thus, the LTHS tests have been replaced by simpler experiments called full notch creep test (FNCT-ISO 16770). In such a test protocol, the target pipe material is compression molded in a plaque (according to ISO 1872-2/ISO 11542-2). From this plaque individual bars of dimensions (100 mm×6 mm×6 mm) were cut (according to ISO 2818) and a notch of 1 mm was machined in the exact middle of each bar. The individual bars were then subjected to constant stresses (to simulate the effect of internal pressures) through pulling apart of the long ends of the bar in a water bath (including 2% of a surfactant, in this situation Arkopal® N100) and at desired temperatures (in this situation 80° C.). The measure of creep of the notch (e.g., an increase in the size and shape thereof) at certain times thus indicates the rate of failure one may predict in terms of the LTHS of pipe made therefrom. This test is not intended to be a replacement for LTHS if such is desired (for measurements of months, for example) and is only utilized as a predictability screen for LTHS for excessive amounts of time (50 years, for example). Thus, different stresses were applied to the sample bars and the time to breakage was recorded for each. A regression according to ISO/DIS 9080 was then followed to calculate the predicted LTHS for each bar up to 50 years time. The stresses were measured as follows:

EXPERIMENTAL TABLE 1
Stress To Break Time Measurements for Each Sample Bar

| Nucleator | Time to Break (hours) | Stress at Break (MPa) |
|---|---|---|
| A | 11 | 7.35 |
| A | 40 | 5.52 |
| A | 108 | 4.01 |
| A | 135 | 3.87 |
| A | 240 | 3.44 |
| A | 378 | 3.04 |
| A | 449 | 2.88 |
| A | 1135 | 2.13 |
| B | 12 | 7.78 |
| B | 70 | 5.85 |
| B | 189 | 4.29 |
| B | 346 | 4.02 |
| B | 578 | 3.56 |
| B | 912 | 3.12 |
| B | 1706 | 2.67 |
| C | 20 | 7.52 |
| C | 56 | 5.63 |
| C | 79 | 5.17 |
| C | 123 | 4.13 |
| C | 219 | 3.68 |
| C | 456 | 3.01 |
| C | 514 | 2.88 |
| C | 913 | 2.21 |
| D | 21 | 7.12 |
| D | 70 | 5.71 |
| D | 104 | 5.11 |
| D | 244 | 4.18 |
| D | 646 | 3.52 |
| D | 1750 | 2.85 |
| D | 1985 | 2.64 |
| (Comparatives) | | |
| E | 5 | 8.76 |
| E | 6 | 9.36 |
| E | 9 | 8.89 |
| E | 11 | 7.93 |
| E | 21 | 6.54 |
| E | 53 | 4.96 |
| E | 54 | 4.27 |
| E | 65 | 4.49 |
| E | 95 | 3.57 |
| E | 217 | 3.03 |
| E | 1145 | 1.96 |
| F | 6 | 9.11 |
| F | 7 | 9.06 |
| F | 8 | 8.1 |
| F | 9 | 8.67 |
| F | 29 | 6.81 |
| F | 59 | 4.77 |
| F | 135 | 3.21 |
| F | 404 | 2.45 |
| F | 898 | 1.88 |
| G | 5 | 7.93 |
| G | 7 | 8.41 |
| G | 10 | 7.64 |
| G | 11 | 7.07 |
| G | 23 | 6.11 |
| G | 42 | 4.97 |
| G | 54 | 5.57 |
| G | 75 | 4.25 |
| G | 214 | 3.02 |
| G | 420 | 2.52 |
| G | 1463 | 1.98 |
| H | 5 | 8.76 |
| H | 8 | 7.85 |
| H | 10 | 8.36 |
| H | 13 | 6.96 |
| H | 34 | 5.99 |
| H | 65 | 4.79 |
| H | 117 | 4.33 |
| H | 208 | 3.55 |
| H | 487 | 3.07 |
| H | 1088 | 2.45 |
| H | 2473 | 1.85 |
| I | 6 | 8.6 |
| I | 7 | 8.59 |
| I | 8 | 7.36 |
| I | 11 | 7.71 |
| I | 14 | 7.91 |
| I | 21 | 5.69 |
| I | 73 | 5.05 |
| I | 125 | 4.1 |
| I | 348 | 3.67 |
| I | 652 | 3.14 |
| I | 1243 | 2.47 |
| I | 2383 | 2.01 |
| J | 5 | 8.14 |
| J | 6 | 8.84 |
| J | 7 | 8.49 |
| J | 17 | 7.54 |
| J | 24 | 5.98 |
| J | 86 | 4.14 |
| J | 325 | 3.08 |
| J | 760 | 2.55 |
| J | 1555 | 1.9 |
| K | 5 | 8.25 |
| K | 8 | 7.29 |
| K | 10 | 8.39 |
| K | 11 | 7.55 |
| K | 33 | 6.01 |
| K | 48 | 5.2 |
| K | 130 | 4.12 |
| K | 450 | 3.28 |
| K | 1293 | 2.64 |
| K | 2650 | 2.24 |
| L | 7 | 7.55 |
| L | 8 | 7.48 |
| L | 21 | 6.29 |
| L | 48 | 5.04 |
| L | 79 | 4.42 |
| L | 136 | 3.77 |
| L | 142 | 3.70 |
| L | 302 | 3.15 |
| L | 689 | 2.64 |
| L | 745 | 2.57 |
| L | 1240 | 2.15 |
| L | 1496 | 2.04 |
| M | 15 | 7.46 |
| M | 22 | 6.34 |
| M | 85 | 4.92 |
| M | 114 | 4.42 |
| M | 145 | 3.80 |
| M | 245 | 3.14 |
| M | 653 | 2.51 |
| M | 769 | 2.46 |
| M | 1287 | 2.04 |
| M | 1345 | 2.01 |

These resultant measurements were then extrapolated to determine the lower prediction limit (LPL) for LTHS (the stress a material can withstand under the current test conditions after 50 years of same pressure exposure and is a measure of the pressure resistance of the material as if it were processed into a pipe article) in accordance with the Standard Extrapolation Method, based on ISO/DIS 9080 (version 1999). In such an extrapolation, the lower prediction limit basically is an estimation of the lowest pressure that will rupture the sample thermoplastic after 50 years of use. Thus, the rupture data above in EXPERIMENTAL TABLE 1 is applied to the equation (in terms of stress at break as a function of time): log t=C(1)+C(2) log σ, where σ is the estimated breakage stress (the LPL), t is time (in hours), and C(1) and C(2) are coefficients determined by regression on the stress rupture measurements. As applied for each of the above sample nucleators (or nonnucleated thermoplastic), the resultant LPL measurements to 50 years estimation appear below. In addition, the ratio comparison of the LPL measurements thereof are provided as well versus the nonucleated sample as an indication of the improvement in ability withstand internal and external pressures for a long period of time (again, extrapolated to 50 years), and thus an indication of the reliability of the sample thermoplastics in terms of long-term hydrostatic strength. The results are as follows:

EXPERIMENTAL TABLE 2
LPL Ratio Measurements for Sample Bars

| | | Ratio Change with |
|---|---|---|
| Nucleator | LPL (MPa) | Nucleator Present |
| E (Control | 0.204 | — |
| Standard) | | |
| A | 0.36 | 1.76 |
| B | 0.758 | 3.72 |
| C | 0.221 | 1.08 |
| D | 0.777 | 3.81 |
| (Comparatives) | | |
| F | 0.166 | 0.814 |
| G | 0.268 | 1.31 |
| H | 0.450 | 2.21 |
| I | 0.465 | 2.28 |
| J | 0.308 | 1.51 |
| K | 0.549 | 2.69 |
| L | 0.473 | 2.32 |
| M | 0.310 | 1.52 |

The results show that by introducing the inventive class of nucleating agents within the target resin, the LPL shows an increase of at least 1.08 (at lower levels) and can exceed 2.75 times, preferably at least 3 times, the LPL of the original non-nucleated resin, and, alternatively at least to a level of 0.6 MPa pressure resistance over such a theoretical long period of time, a level heretofore unattained for nucleated resins. Such inventive nucleated resins thus provide at least effective ability to withstand long-term hydrostatic pressures, if not unexpectedly good and reliable thermoplastics for long-term pressure-resistant pipe (and similar object) end-uses.

Samples of the inventive resins were then used to extrude pipes suitable for installation underground and to transport various liquids and/or gases therein.

Having described the invention in detail it is obvious that one skilled in the art will be able to make variations and modifications thereto without departing from the scope of the present invention. Accordingly, the scope of the present invention should be determined only by the claims appended hereto.

1. A high-pressure thermoplastic article comprising a thermoplastic formulation, wherein said thermoplastic comprises at least one nucleating agent selected from the group consisting of compounds conforming with either of formulae (I) or (II) or mixtures thereof 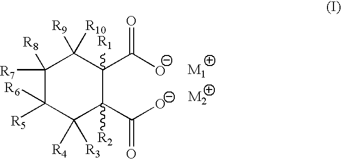
wherein M₁ and M₂ are the same or different or are combined to form a single moiety and are selected from at least one metal cation, and wherein R₁, R₂, R₃, R₄, R₅, R₆, R₇, R₈, R₉, and R₁₀ are either the same or different and are individually selected from the group consisting of hydrogen, C₁-C₉ alkyl (wherein any two vicinal or geminal alkyl groups may be combined to form a carbocyclic ring of up to six carbon atoms), hydroxy, C₁-C₉ alkoxy, C₁-C₉ alkyleneoxy, amine, and C₁-C₉ alkylamine, halogen, and phenyl, wherein geminal constituents may be the same except that such geminal constituents cannot simultaneously be hydroxy; and wherein geminal constituents may be different from each other, except that such geminal constituents may not be hydroxy and halogen or hydroxy and amine simultaneously; 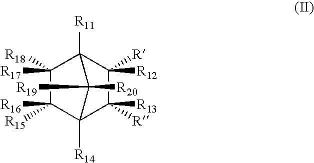
wherein R₁₁, R₁₂, R₁₃, R₁₄, R₁₅, R₁₆, R₁₇, R₁₈, R₁₉, and R₂₀ are individually selected from the group consisting of hydrogen, C₁-C₉ alkyl, hydroxy, C₁-C₉ alkoxy, C₁-C₉ alkyleneoxy, amine, and C₁-C₉ alkylamine, halogen, phenyl, alkylphenyl, and geminal or vicinal carbocyclic having up to nine carbon atoms, wherein geminal constituents may be the same except that such geminal constituents cannot simultaneously be hydroxy; and wherein geminal constituents may be different from each other, except that such geminal constituents may not be hydroxy and halogen or hydroxy and amine simultaneously; wherein R′ and R″ are the same or different and are individually selected from the group consisting of hydrogen, C₁-C₃₀ alkyl, hydroxy, amine, polyoxyamine, C₁-C₃₀ alkylamine, phenyl, halogen, C₁-C₃₀ alkoxy, C₁-C₃₀ polyoxyalkyl, C(O)—NR₂₁C(O), and C(O)O—R′″, wherein R₂₁ is selected from the group consisting of C₁-C₃₀ alkyl, hydrogen, C₁-C₃₀ alkoxy, and C₁-C₃₀ polyoxyalkyl, and wherein R′″ alone or two adjacent R′″ groups (such as when R′ and R″ are the same) are combined to from a single moiety which is selected from the group consisting of hydrogen, a metal ion, an organic cation, polyoxy-C₂-C₁₈-alkylene, C₁-C₃₀ alkyl, C₁-C₃₀ alkylene, C₁-C₃₀ alkyleneoxy, a steroid moiety, phenyl, polyphenyl, C₁-C₃₀ alkylhalide, and C₁-C₃₀ alkylamine; and wherein at least one of R′ and R″ is either C(O)—NR₂₁C(O) or C(O)O—R′″.

2. The article of claim 1 wherein said article is a pipe.

3. A method of producing the nucleated thermoplastic formulation of claim 1, wherein said method comprises the steps of introducing at least one at least one nucleating agent selected from the group consisting of compounds conforming with either of formulae (I) or (II) or mixtures thereof 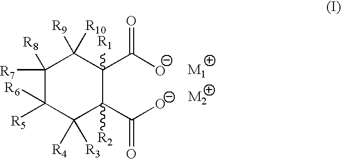
wherein M₁ and M₂ are the same or different or are combined to form a single moiety and are selected from at least one metal cation, and wherein R₁, R₂, R₃, R₄, R₅, R₆, R₇, R₈, R₉, and R₁₀ are either the same or different and are individually selected from the group consisting of hydrogen, C₁-C₉ alkyl (wherein any two vicinal or geminal alkyl groups may be combined to form a carbocyclic ring of up to six carbon atoms), hydroxy, C₁-C₉ alkoxy, C₁-C₉ alkyleneoxy, amine, and C₁-C₉ alkylamine, halogen, and phenyl, wherein geminal constituents may be the same except that such geminal constituents cannot simultaneously be hydroxy; and wherein geminal constituents may be different from each other, except that such geminal constituents may not be hydroxy and halogen or hydroxy and amine simultaneously; 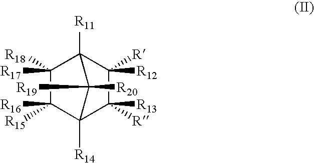
wherein R₁₁, R₁₂, R₁₃, R₁₄, R₁₅, R₁₆, R₁₇, R₁₈, R₁₉, and R₂₀ are individually selected from the group consisting of hydrogen, C₁-C₉ alkyl, hydroxy, C₁-C₉ alkoxy, C₁-C₉ alkyleneoxy, amine, and C₁-C₉ alkylamine, halogen, phenyl, alkylphenyl, and geminal or vicinal carbocyclic having up to nine carbon atoms, wherein geminal constituents may be the same except that such geminal constituents cannot simultaneously be hydroxy; and wherein geminal constituents may be different from each other, except that such geminal constituents may not be hydroxy and halogen or hydroxy and amine simultaneously; wherein R′ and R″ are the same or different and are individually selected from the group consisting of hydrogen, C₁-C₃₀ alkyl, hydroxy, amine, polyoxyamine, C₁-C₃₀ alkylamine, phenyl, halogen, C₁-C₃₀ alkoxy, C₁-C₃₀ polyoxyalkyl, C(O)—NR₂₁C(O), and C(O)O—R′″, wherein R₂₁ is selected from the group consisting of C₁-C₃₀ alkyl, hydrogen, C₁-C₃₀ alkoxy, and C₁-C₃₀ polyoxyalkyl, and wherein R′″ alone or two adjacent R′″ groups (such as when R′ and R″ are the same) are combined to from a single moiety which is selected from the group consisting of hydrogen, a metal ion, an organic cation, polyoxy-C₂-C₁₈-alkylene, C₁-C₃₀ alkyl, C₁-C₃₀ alkylene, C₁-C₃₀ alkyleneoxy, a steroid moiety, phenyl, polyphenyl, C₁-C₃₀ alkylhalide, and C₁-C₃₀ alkylamine; and wherein at least one of R′ and R″ is either C(O)-NR₂₁C(O) or C(O)O—R′″,
into a molten thermoplastic composition and permitting such a nucleated formulation to cool into a nucleated, solid thermoplastic formulation.

4. A method of producing a nucleated thermoplastic pipe, wherein said method comprises the steps of introducing at least one at least one nucleating agent selected from the group consisting of compounds conforming with either of formulae (I) or (II) or mixtures thereof 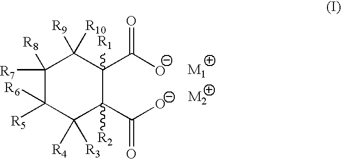
wherein M₁ and M₂ are the same or different or are combined to form a single moiety and are selected from at least one metal cation, and wherein R₁, R₂, R₃, R₄, R₅, R₆, R₇, R₈, R₉, and R₁₀ are either the same or different and are individually selected from the group consisting of hydrogen, C₁-C₉ alkyl (wherein any two vicinal or geminal alkyl groups may be combined to form a carbocyclic ring of up to six carbon atoms), hydroxy, C₁-C₉ alkoxy, C₁-C₉ alkyleneoxy, amine, and C₁-C₉ alkylamine, halogen, and phenyl, wherein geminal constituents may be the same except that such geminal constituents cannot simultaneously be hydroxy; and wherein geminal constituents may be different from each other, except that such geminal constituents may not be hydroxy and halogen or hydroxy and amine simultaneously; 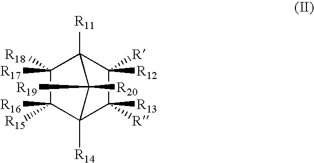
wherein R₁₁, R₁₂, R₁₃, R₁₄, R₁₅, R₁₆, R₁₇, R₁₈, R₁₉, and R₂₀ are individually selected from the group consisting of hydrogen, C₁-C₉ alkyl, hydroxy, C₁-C₉ alkoxy, C₁-C₉ alkyleneoxy, amine, and C₁-C₉ alkylamine, halogen, phenyl, alkylphenyl, and geminal or vicinal carbocyclic having up to nine carbon atoms, wherein geminal constituents may be the same except that such geminal constituents cannot simultaneously be hydroxy; and wherein geminal constituents may be different from each other, except that such geminal constituents may not be hydroxy and halogen or hydroxy and amine simultaneously; wherein R′ and R″ are the same or different and are individually selected from the group consisting of hydrogen, C₁-C₃₀ alkyl, hydroxy, amine, polyoxyamine, C₁-C₃₀ alkylamine, phenyl, halogen, C₁-C₃₀ alkoxy, C₁-C₃₀ polyoxyalkyl, C(O)—NR₂₁C(O), and C(O)O—R′″, wherein R₂₁ is selected from the group consisting of C₁-C₃₀ alkyl, hydrogen, C₁-C₃₀ alkoxy, and C₁-C₃₀ polyoxyalkyl, and wherein R′″ alone or two adjacent R′″ groups (such as when R′ and R″ are the same) are combined to from a single moiety which is selected from the group consisting of hydrogen, a metal ion, an organic cation, polyoxy-C₂-C₁₈-alkylene, C₁-C₃₀ alkyl, C₁-C₃₀ alkylene, C₁-C₃₀ alkyleneoxy, a steroid moiety, phenyl, polyphenyl, C₁-C₃₀ alkylhalide, and C₁-C₃₀ alkylamine; and wherein at least one of R′ and R″ is either C(O)—NR₂₁C(O) or C(O)O—R′″,
(i) into a molten thermoplastic composition,
(ii) extruding said molten thermoplastic composition into the shape of a pipe, and
(iii) permitting such a nucleated formulation to cool into a nucleated, solid thermoplastic pipe.
